(19) United States
(12) Patent Application Publication
(10) Pub. No.: US 2024/0059553 A1
(43) Pub. Date: Feb. 22, 2024

(54) FORCE REDUCING SADDLE PAD

(71) Applicant: Lauren Jessica RASALINGAM, Ottawa (CA)

(72) Inventor: Lauren Jessica RASALINGAM, Ottawa (CA)

(21) Appl. No.: 18/114,551

(22) Filed: Feb. 27, 2023

Related U.S. Application Data
(60) Provisional application No. 63/399,098, filed on Aug. 18, 2022.

(51) Int. Cl. B68C 1/12

(52) U.S. Cl. CPC B68C 1/12

(57) ABSTRACT

The present invention provides a saddle pad comprising a force dissipation material, said force dissipation material comprising a dry visoelastic polymer. The dry visoelastic polymer may be SHOCKtec gel™ or SHOCKtec Air2Gel™.

### FIELD OF THE INVENTION

The present invention relates to a saddle pad. In particular, the present invention relates to a saddle pad which reduces the force and pressure on the horse's back while the horse is being ridden.

### BACKGROUND

Saddle pads are the material placed between the saddle and the horse's back used to absorb sweat, reduce friction and decrease pressure on the horse's back. Saddle pads are made from many different materials. In 2010 Kotschwar showed that a saddle pad made from reindeer fur was slightly better than gel, foam or leather at reducing pressure (Lesté, 2019). It has been suggested that reindeer fur is similar to sheepskin. Despite the fact that there are gel saddle pads on the market, and some manufacturers claim they reduce pressure, there is little to no evidence of this in the scientific literature and certainly not in the equine school setting. The optimal condition for the horse is to have a horse-saddle pad-saddle system that is individualized for each rider. Depending on the rider size and riding style the forces and pressure points can vary. When the system is not optimal, excessive pressure on the horse's back can cause damage which manifests as physical symptoms and performance problems of the horse (Harman, 2016).

The saddle, and forces on the horse's back while riding should not cause trauma to the horse's skin or muscles. This force can be measured as maximum overall force (MOF) in Newtons (N), peak pressure (N/cm²) and average pressure (N/cm²). Persistent excessive pressure can stop capillary blood flow. When pressure results in capillary collapse the effect can progress from hypoxia, to atrophy, to pain, to decreased performance, then sores and finally secondary issues such as infection (Clayton, 2016). Peinen found that at an average pressure of 1.53 N/cm² and a maximum pressure of 3.1 N/cm² resulted in horses being at risk for developing muscle soreness and saddle sores (von Peinen, 2010, 652).

The forces on a horse's back are largely influenced by the rider's mass and gravitational forces. This is quite consistent at a stand still and at a walk gait where the force on the horse's back is essentially mass×acceleration where acceleration is gravity. However, in the trot, canter and during a jump, the forces on the horse's back increase. For example, when landing a jump, the downward kinetic energy is countered by the horse's back. Furthermore, these biomechanical forces on the horse's back, and their dispersion, can be influenced by many variables such as saddle fit, rider level, the consistency of the horse's motion, and changes in horse's musculature (Kotschwar, 2010). One purpose of saddle pads is to even out this pressure distribution which is even more important in the equine school setting because there is not a customized horse-pad-saddle system and yet the horse is ridden by many different people.

### SUMMARY OF THE INVENTION

An object of the present invention is to provide a force reducing saddle pad. In accordance with an aspect of the present invention, there is provided a saddle pad comprising a force dissipation material, said force dissipation material comprising a dry visoelastic polymer. In certain embodiments the force dissipation material comprises SHOCKtec gel™ or SHOCKtec Air2Gel™.

### BRIEF DESCRIPTION OF THE FIGURES

FIG. 1 provides various line drawings of a saddle pad of an embodiment of the present invention.

FIG. 2 provides a cutaway line drawing of a saddle pad of an embodiment of the present invention.

FIG. 3 provides a drawing of a saddle pad of an embodiment of the present invention.

FIG. 4 provides a drawing of the shape of the force dissipation material in the side portion of a saddle pad of an embodiment of the present invention.

FIG. 5 provides a cutaway line drawing of a saddle pad of an embodiment of the present invention.

FIG. 6 illustrates the design of the experiments to measure force.

FIG. 7 illustrates the maximum overall force (MOF) recorded when various commercially available prior art saddle pads are used.

FIG. 8 illustrates peak pressure in N/cm² when various commercially available prior art saddle pads are used.

FIG. 9 illustrates average pressure in N/cm² when various commercially available prior art saddle pads are used.

FIG. 10 illustrates maximum overall force (N) with different materials.

FIG. 11 illustrates peak pressure in N/cm² with different materials.

FIG. 12 illustrates average pressure in N/cm² with different materials.

FIG. 13 illustrates maximum overall force (N) with different materials.

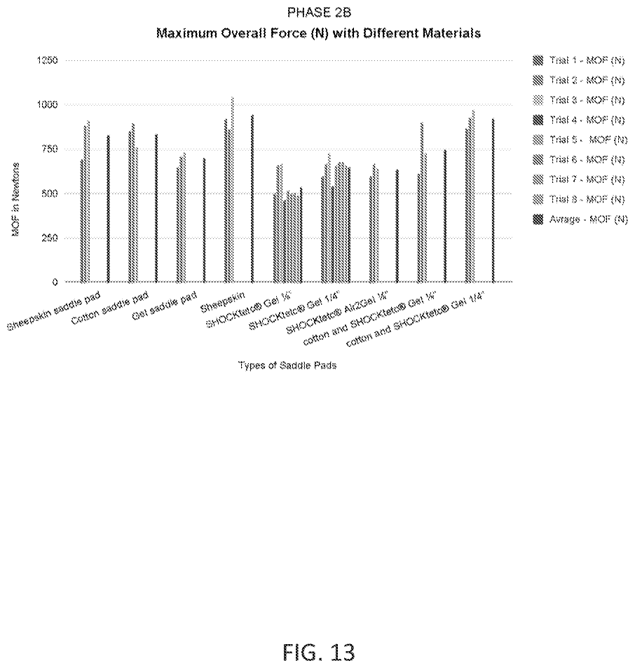

FIG. 14 illustrates peak pressure in N/cm² with different materials.

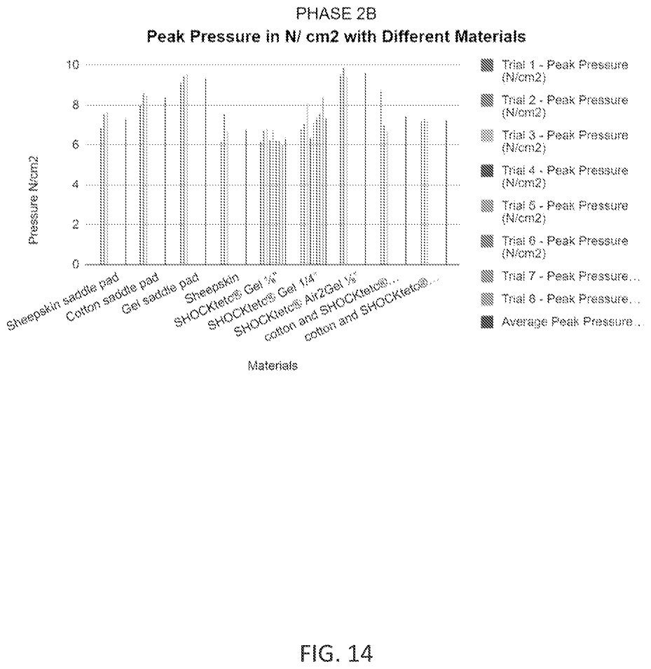

FIG. 15 illustrates average pressure in N/cm² with different materials.

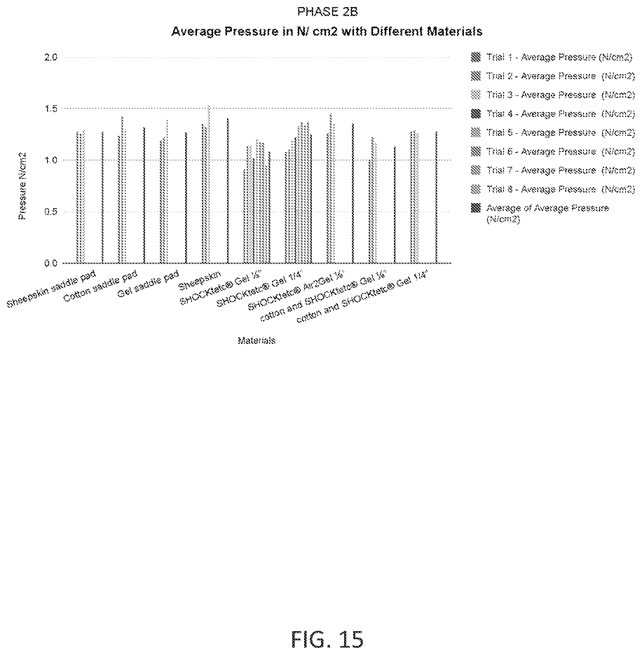

FIG. 16 illustrates MOF of a cotton saddle pad vs. an engineered saddle pad of an embodiment of the present invention.

FIG. 17 illustrates peak pressure of a cotton saddle pad vs. an engineered saddle pad of an embodiment of the present invention.

FIG. 18 illustrates average pressure of a cotton saddle pad vs. an engineered saddle pad of an embodiment of the present invention.

FIG. 19 illustrates percent reduction of force and pressure.

FIG. 20 provides an example pressure distribution map.

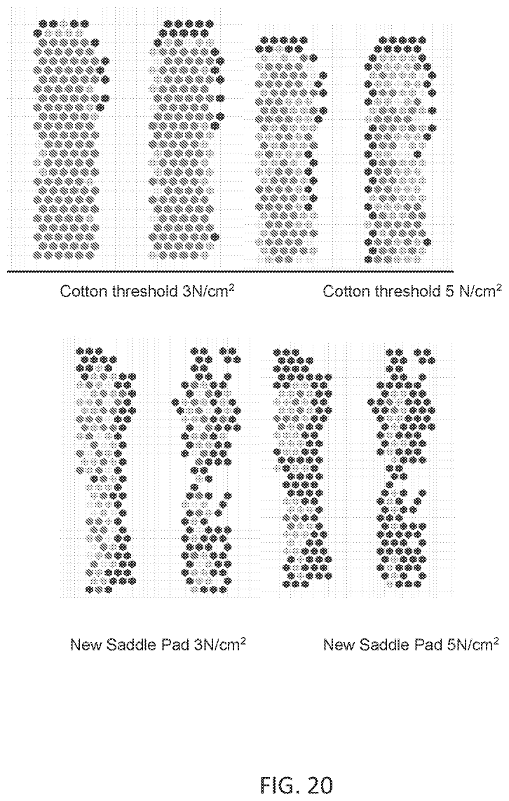

### DETAILED DESCRIPTION

The present invention provides a saddle pad which reduces the force and pressure on a horse's back while the horse is being ridden. In particular, the present invention provides a saddle pad comprising a force dissipation material. The force dissipation material may include one or more porous elastic materials, such as elastomer foams. In one embodiment, the material comprises a polyurethane foam. In certain embodiments, the material comprises a dry visoelastic polymer. In specific embodiments, the material comprises an air-frothed visoelastic dry polymer.

Suitable, commercially available materials are known in the art and include but are not limited to SHOCKtec gel™ and SHOCKtec Air2Gel™. The properties of various SHOCKtec materials are available at https://shocktec.com/specs-and-msds/.

Accordingly, in certain embodiments there is provided a saddle pad comprising a polyurethane foam. In certain embodiments, there is provided a saddle pad comprising a dry visoelastic polymer. In certain embodiments, the saddle pad comprises an air-frothed visoelastic dry polymer. In specific embodiments, there is provided a saddle pad comprising SHOCKtec gel™. In specific embodiments, there is provided a saddle pad comprising SHOCKtec Air2Gel™.

In certain embodiments force dissipation material forms a layer in the saddle pad. In certain embodiments, the thickness of the layer of force dissipation material in the saddle pad is ⅛ inch, ¼ inch or ⅜ inch. In specific embodiments, the thickness is ⅛ inch. The layer of force dissipation material may be sized to include entire area of the saddle pad or a portion thereof. In particular, the force dissipation material may be positioned in the saddle pad to cover the areas on a horse's back that are subject to the greatest force.

In certain embodiments, the force dissipation material is removable from the saddle pad. In such embodiments, the saddle pad may include one or more pockets to secure the force dissipation material.

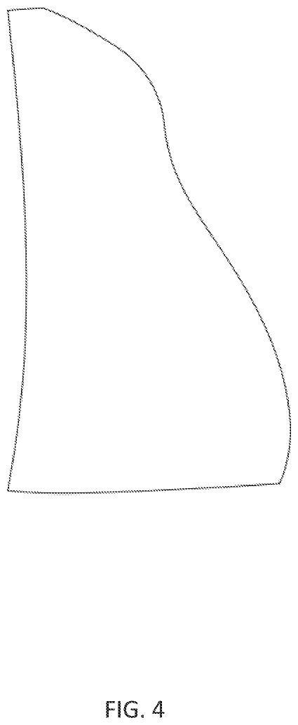

In certain embodiments, the saddle pad comprises a spine portion and two side portions extending out from each side of the spine portion. In specific embodiments, the spine portion does not include a layer of force dissipation material. In specific embodiments, each side portion comprises a layer of force dissipation material. In certain embodiments, the force dissipation layer is shaped to cover the areas on a horse's back that are subject to the greatest force. In specific embodiments, the layer of force dissipation material on each side extends from the spine and is contoured to generally follow the shape of the saddle. FIG. 4 provides a non-limiting example of the shape of the force dissipation material in the side portion of a saddle pad of an embodiment of the present invention.

In certain embodiments, the saddle pad further comprises one or more additional layers. The additional layers may include but are not limited to foam layers and outer coverings.

In certain embodiments, the saddle pad of the present invention further comprises an outer shell. The outer shell may be constructed of various materials including but not limited to cotton, polyester, wool or blends thereof and combinations thereof. The material may be moisture wicking, antimicrobial and/or breathable. The outer shell may be quilted. The portion of the outer shell in contact with the horse may be constructed from the same or different material to the portion of the outer shell in contact with the saddle.

In certain embodiments, the saddle pad of the present invention further comprises one or more layers of foam. In specific embodiments, the saddle pad of the present invention further comprises soft open cell polyurethane foam. The thickness of the foam may be consistent or may be variable. For example, the foam may be thicker in areas of the saddle pad which cover the areas on a horse's back that are subject to the greatest force. In certain embodiments, the polyurethane foam is ⅛″ thick. The layer of foam may be sized to include entire planar area of the saddle pad or a portion thereof.

The saddle pad may be a variety of shapes. A worker skilled in the art would readily appreciate that the shape of the pad may depend on the use of the saddle pad. For example, the saddle pad may be shaped for all purpose or shaped for particular uses. For example, the saddle pad may be shaped for use with a Western saddle, English saddle including but not limited to a close contact saddle, jumper saddle or dressage saddle. The saddle pad may also be shaped to follow the contours of the saddle or be in the form of a half pad. The saddle pad may also include one or more cut outs. For example, the saddle pad may include a wither release cut out.

In certain embodiments, the saddle pad includes a removable cover.

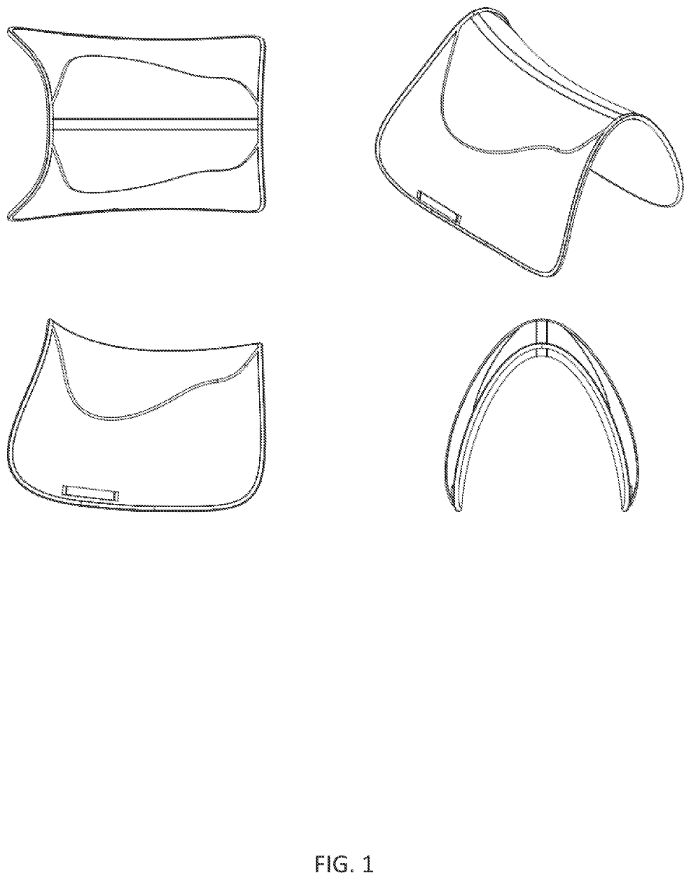

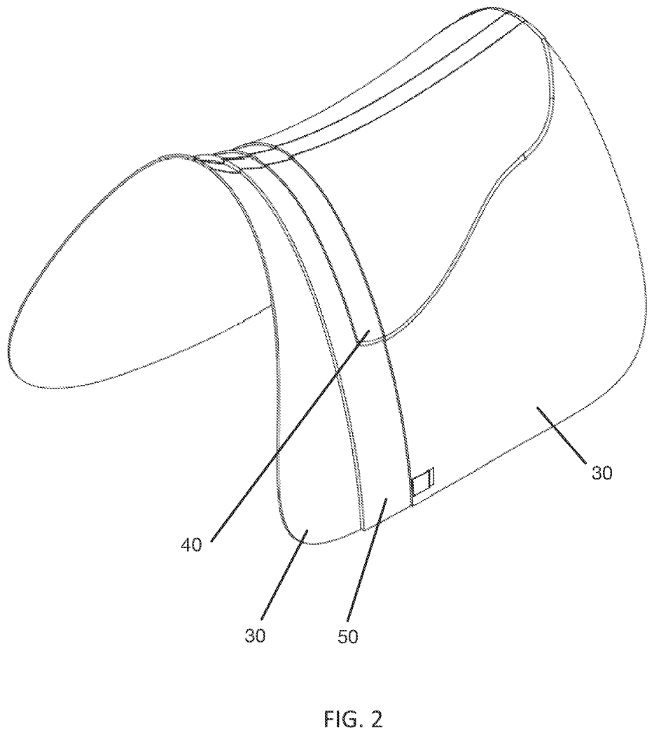

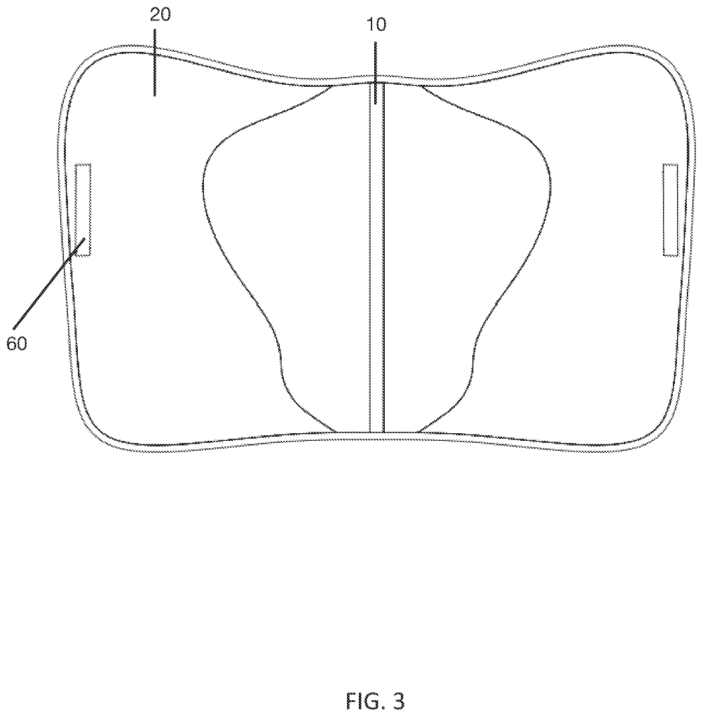

Exemplary embodiments of the saddle pad of the present invention are described with reference to the FIGS. 1 to 5. In this embodiment, the saddle pad is an all-purpose saddle pad having a generally square shape and comprising a spine portion (10) and two side portions (20) extending out from each side of the spine portion. The saddle pad of this exemplary embodiment comprises an outer shell (30), a force dissipation layer (40) and a foam layer (50). In this embodiment, the outer shell is a quilted material such as a cotton polyester blend. In this embodiment, a girth strap (60) is positioned near the bottom towards the front of each side portion of the saddle pad. In this embodiment, a layer of foam is between the portion of the outer shell in contact with the horse and the force dissipation layer. In this embodiment the layer of foam is generally the same shape as the saddle pad.

In this embodiment, each of the side portions comprise a force dissipation layer. In this embodiment, the force dissipation layer is contoured to generally follow the shape of the saddle. In this embodiment, the force dissipation layer is secured with for example a turn-seam outline.

### Examples

### Testing Prior Art Saddle Pads

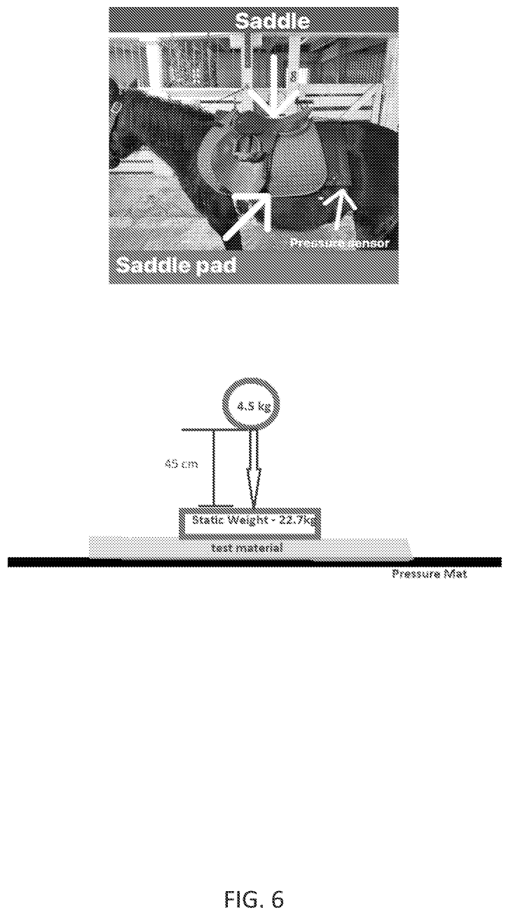

The Estride Harmony G3 pressure mat was used. The Estride Harmony G3 pressure mat is a pressure sensor mat created to help in understanding the pressures on a horse's back. The mat has 1 sensor per cm², is battery powered with a rechargeable battery and is rated for −20 degrees Celsius to plus 50 degrees Celsius. The minimum recordable pressure is 0.01 N/cm². The data is transferred from the mat by Bluetooth to a phone via the Estride Harmony app. This recorded data can then be synced via WIFI to the MyEstride software. This software allows analysis for understanding overall saddle fit, based on pressure on spine, left versus right balance, front versus back pressure and average pressure. The analysis provides a score out of 10 for each of these measures and a total score out of 40. It also measures rider balance and looks specifically at pressure distributions and specific pressure points. The mat has the ability to show pressure concentrations which takes into account the amount of pressure applied to adjacent pressure sensors. This is displayed only as a concentration map. The pressure map shows the individual pressures on each sensor and also calculates the total pressure, also known as maximum overall force in N (MOF), peak pressure in N/cm² and average pressure in N/cm². (Estride, n.d.) Pressure was measured while riding or using a weight dropped from a height using the following procedures:
Procedure 1: The horse was tacked up with the estride saddle mat (pressure sensor) directly on the horse's back and underneath the saddle pad to be tested (see FIG. 6, top). Pressure was measured when the horse was ridden over one 2 foot jump at a canter.
Procedure 2: A 4.5 kg weight was dropped onto the material or combination of materials being tested from a height of 45 cm (see FIG. 6, bottom). The material or material combination being tested per list below:

| | |
|---|---|
| Sheepskin saddle pad | Slime (made with 946 ml white |
| Cotton saddle pad | elmers glue, 126 grams model |
| Gel saddle pad | magic clay, 20 ml baking soda, 53 |
| Sheepskin | ml contact solution |
| SHOCKtetc ® Gel ⅛″ | SHOCKtetc ® Gel ⅛″ AND cotton |
| SHOCKtetc ® Gel ¼″ | saddle pad |
| SHOCKtetc ® Air2Gel ⅛″ | SHOCKtetc ® Gel ¼″ AND cotton |
| | saddle pad |

PHASE 1: Testing Commercial Saddle Pads

TABLE 1
Commercial Saddle Pads-Measurement of Pressure on Spine

| | Trial 1- | Trial 2- | Trial 3- | Pressure on |
|---|---|---|---|---|
| Types of | Pressure on | Pressure on | Pressure on | Spine Average |
| saddle | Spine (score | Spine (score | Spine (score | (score out of |
| pad | out of 10) | out of 10) | out of 10) | 10) |
| Sheepskin | 3 | 3 | 3 | 3 |
| Gel | 3 | 3 | 3 | 3 |
| Cotton | 3 | 3 | 3 | 3 |

Pressure on Spine was given a score out 10. The software analyzes the pressure distribution very close to the centerline of the pressure mat which lies over the horse's spine. If 5-9 adjacent pressure points are triggered then there is a minor pressure warning (7-8/10), if 10-14 adjacent pressure points are triggered then there is a warning (5-6/10) and if more than 15 adjacent pressure points are triggered then the software indicates that attention is required (≤4/10).

TABLE 2
Commercial Saddle Pads-Measurement of Maximum Overall Force
(MOF) in Newtons (N)

| Types of saddle | Trial 1-MOF | Trial 2-MOF | Trial 3-MOF | Average-MOF |
|---|---|---|---|---|
| pad | (N) | (N) | (N) | (N) |
| Sheepskin | 1625.78 | 1849.09 | 1767.08 | 1747.32 |
| Gel | 2222.11 | 1933.38 | 1835.06 | 1996.85 |
| Cotton | 2168.16 | 1951.10 | 1934.04 | 2017.77 |

TABLE 3
Commercial Saddle Pads-Peak Pressure in N/cm²

| | Trial 1-Peak | Trial 2-Peak | Trial 3-Peak | Average-Peak |
|---|---|---|---|---|
| Types of | Pressure | Pressure | Pressure | Pressure |
| saddle pad | (N/cm2) | (N/cm2) | (N/cm2) | (N/cm2) |
| Sheepskin | 6.47 | 6.89 | 7.05 | 6.80 |
| Gel | 7.53 | 7.14 | 7.05 | 7.24 |
| Cotton | 6.67 | 7.1 | 6.82 | 6.86 |

TABLE 4
Commercial Saddle Pads-Average Pressure in N/cm²

| | Trial 1- | Trial 2- | Trial 3- | Average- |
|---|---|---|---|---|
| Types of | Average | Average | Average | Average |
| saddle | Pressure | Pressure | Pressure | Pressure |
| pad | (N/cm2) | (N/cm2) | (N/cm2) | (N/cm2) |
| Sheepskin | 1.24 | 1.18 | 1.23 | 1.22 |
| Gel | 1.34 | 1.32 | 1.22 | 1.29 |
| Cotton | 1.37 | 1.25 | 1.3 | 1.31 |

% reduction between from cotton to sheepskin: 6.9%

The score for the pressure on the spine, indicating whether or not there is pressure on the spine, is identical for all 3 saddle pads and consistent across trials. This indicates that the commercial saddle pads do not affect the pressure on the spine.

The Maximum Overall Force (MOF) recorded when the sheepskin saddle pad is used was slightly lower than the tests with the other commercial saddle pads (see FIG. 1).

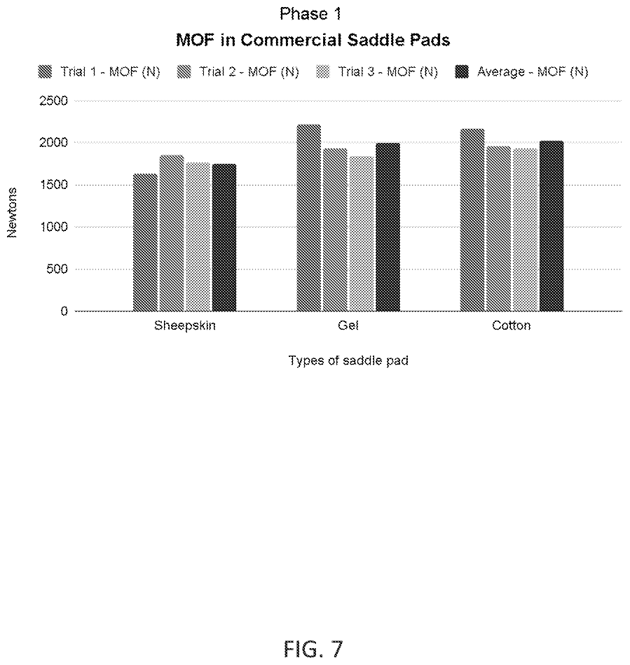

There is very little variation in the peak pressures with the prior art saddle pads tested (see FIG. 7).

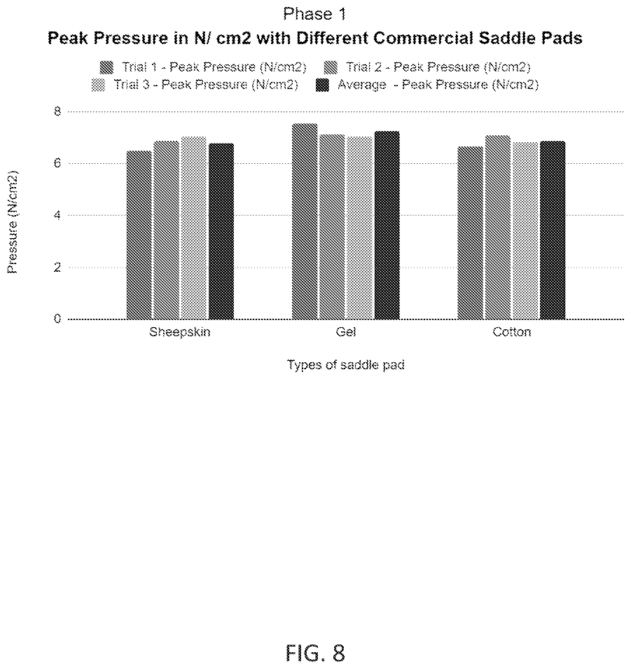

Although the average pressure recorded when using the sheepskin saddle pad was consistently the lowest, there was only a slight difference seen between the prior art saddle pads tested (see FIG. 8).

PHASE 2A—Testing Shock Absorption of Various Materials

TABLE 5
Material Testing-Maximum Overall Force (MOF) measured in Newtons (N)

| | Trial 1- | Trial 2- | Trial 3- | Average- |
|---|---|---|---|---|
| | MOF (N) | MOF (N) | MOF (N) | MOF (N) |
| Sheepskin saddle pad | 463.6 | 502.1 | 493.5 | 486.4 |
| Cotton saddle pad | 398.6 | 389.6 | 391.6 | 393.3 |
| Gel saddle pad | 402.5 | 447.3 | 471.9 | 440.6 |
| Sheepskin | 478.3 | 534.4 | 534.2 | 515.6 |
| SHOCKtetc ® Gel ⅛″ | 249.2 | 258.8 | 296.7 | 268.2 |
| SHOCKtetc ® Gel ¼″ | 345.9 | 331.9 | 320.0 | 332.6 |
| SHOCKtetc ® Air2Gel | 302.4 | 353.6 | 354.3 | 336.8 |
| ⅛″ | | | | |
| Slime | 424.8 | 446.3 | 472.1 | 447.7 |

TABLE 5
Material Testing-Peak Pressure measured in Newtons (N/cm²)

| | Trial 1-Peak | Trial 2-Peak | Trial 3-Peak | Average-Peak |
|---|---|---|---|---|
| | Pressure | Pressure | Pressure | Pressure |
| | (N/cm2) | (N/cm2) | (N/cm2) | (N/cm2) |
| Sheepskin saddle pad | 5.5 | 5.3 | 5.2 | 5.3 |
| Cotton saddle pad | 4.0 | 4.1 | 4.4 | 4.2 |
| Gel saddle pad | 5.1 | 5.4 | 5.4 | 5.3 |
| Sheepskin | 4.6 | 4.7 | 4.8 | 4.7 |
| SHOCKtetc ® Gel ⅛″ | 3.8 | 3.6 | 4.3 | 3.9 |
| SHOCKtetc ® Gel ¼″ | 4.4 | 4.2 | 4.1 | 4.2 |
| SHOCKtetc ® Air2Gel ⅛″ | 4.9 | 4.4 | 4.3 | 4.5 |
| Slime | 5.0 | 5.1 | 5.1 | 5.1 |

TABLE 6
Material Testing-Average Pressure measured in Newtons (N/cm²)

| | Trial 1- | Trial 2- | Trial 3- | Average- |
|---|---|---|---|---|
| | Average | Average | Average | Average |
| | Pressure | Pressure | Pressure | Pressure |
| | (N/cm2) | (N/cm2) | (N/cm2) | (N/cm2) |
| Sheepskin saddle pad | 0.88 | 0.98 | 0.95 | 0.94 |
| Cotton saddle pad | 0.66 | 0.71 | 0.75 | 0.71 |
| Gel saddle pad | 1.02 | 0.96 | 0.95 | 0.98 |
| Sheepskin | 1.03 | 1.18 | 1.18 | 1.13 |
| SHOCKtetc ® Gel ⅛″ | 0.50 | 0.52 | 0.59 | 0.54 |
| SHOCKtetc ® Gel ¼″ | 0.72 | 0.67 | 0.66 | 0.68 |
| SHOCKtetc ® Air2Gel ⅛″ | 0.59 | 0.68 | 0.68 | 0.65 |
| Slime | 1.04 | 0.99 | 1.14 | 1.06 |

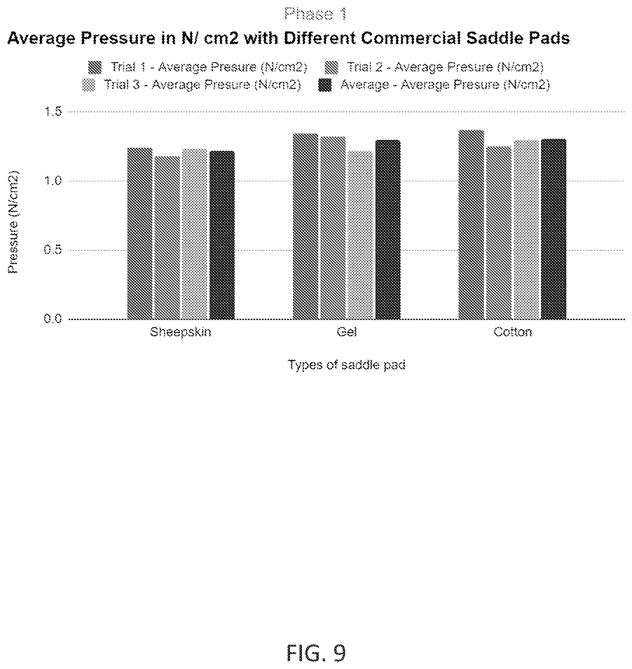

All three of the SHOCKtec gel materials reduce the maximum overall force (MOF) the most and the SHOCKtec ⅛″ gel consistently records the lowest MOF (see FIG. 9).

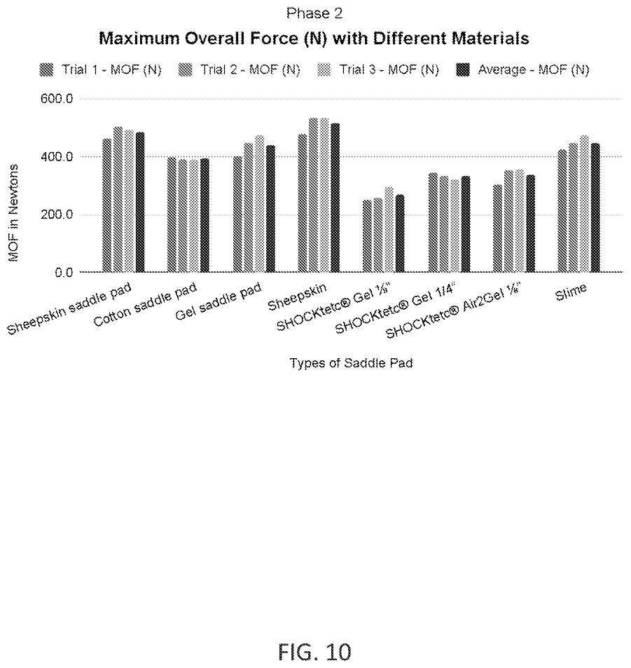

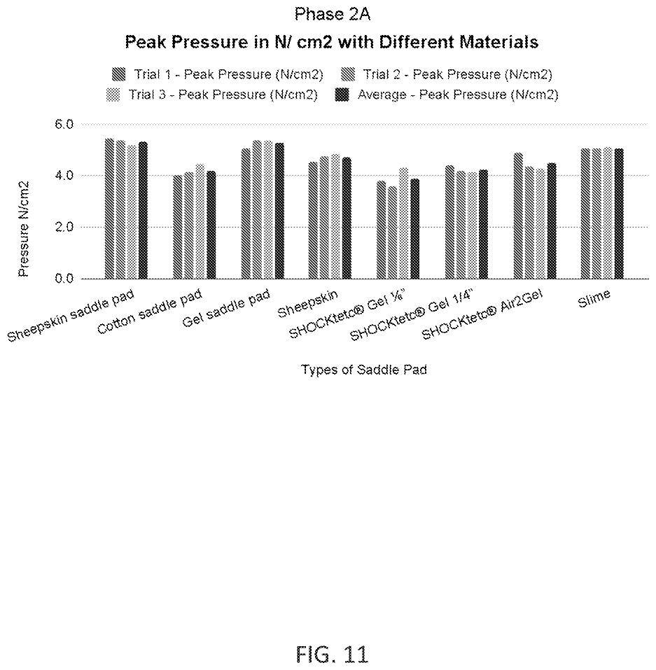

The peak pressures recorded with various materials are less different than the MOF or average pressures seen in FIGS. 9 and 11. However, the material that resulted in the lowest peak pressure measurements was the SHOCKtec gel ⅛″ (see FIG. 10).

The average pressure recordings for the SHOCKtec gel ⅛″ are the lowest followed by the other two SHOCKtec materials. (see FIG. 6)

PHASE 2B—Testing Shock Absorption of Various Materials

Phase 2B uses a 501b static weight and 10 lb dropped weight to scale the material testing to mimic average pressures seen during in vivo testing in phase 1.

TABLE 7
Material Testing - Maximum Overall Force (MOF) measured in Newtons (N)

| | Trial 1 - | Trial 2 - | Trial 3 - | Trial 4 - | Trial 5 - | Trial 6 - | Trial 7 - | Trial 8 - | Average |
|---|---|---|---|---|---|---|---|---|---|
| | MOF (N) | MOF (N) | MOF (N) | MOF (N) | MOF (N) | MOF (N) | MOF (N) | MOF (N) | MOF (N) |
| Sheepskin saddle pad | 691.6 | 882.2 | 913.9 | | | | | | 829.23 |
| Cotton saddle pad | 855.8 | 895.8 | 759.7 | | | | | | 837.08 |
| Gel saddle pad | 650.5 | 710.3 | 732.8 | | | | | | 697.87 |
| Sheepskin | 919.1 | 863.1 | 1042.9 | | | | | | 941.69 |
| SHOCKtetc ® Gel ⅛″ | 498.6 | 658.4 | 667.0 | 461.82 | 515.8 | 499.5 | 501.6 | 488.21 | 536.36 |
| SHOCKtetc ® Gel ¼″ | 597.9 | 665.9 | 729.6 | 539.61 | 658.9 | 676.9 | 677.1 | 657.97 | 650.47 |
| SHOCKtetc ® Air2Gel ⅛″ | 595.1 | 665.5 | 645.1 | | | | | | 635.23 |
| cotton and SHOCKtetc ® | 613.1 | 899.0 | 729.2 | | | | | | 747.09 |
| Gel ⅛″ | | | | | | | | | |
| cotton and SHOCKtetc ® | 867.7 | 926.7 | 970.9 | | | | | | 921.74 |
| Gel ¼″ | | | | | | | | | |

TABLE 8
Material Testing - Peak Pressure measured in Newtons (N/cm²)

| | Trial 1 - | Trial 2 - | Trial 3 - | Trial 4 - | Trial 5 - | Trial 6 - | Trial 7 - | Trial 8 - | Average |
|---|---|---|---|---|---|---|---|---|---|
| | Peak | Peak | Peak | Peak | Peak | Peak | Peak | Peak | Peak |
| | Pressure | Pressure | Pressure | Pressure | Pressure | Pressure | Pressure | Pressure | Pressure |
| | (N/cm2) | (N/cm2) | (N/cm2) | (N/cm2) | (N/cm2) | (N/cm2) | (N/cm2) | (N/cm2) | (N/cm2) |
| Sheepskin saddle pad | 6.8 | 7.5 | 7.7 | | | | | | 7.3 |
| Cotton saddle pad | 8.0 | 8.6 | 8.5 | | | | | | 8.4 |
| Gel saddle pad | 9.1 | 9.5 | 9.6 | | | | | | 9.4 |
| Sheepskin | 6.2 | 7.5 | 6.7 | | | | | | 6.8 |
| SHOCKtetc ® Gel ⅛″ | 6.2 | 6.7 | 6.8 | 6.22 | 6.73 | 6.17 | 6.17 | 6.01 | 6.4 |
| SHOCKtetc ® Gel ¼″ | 6.8 | 7.1 | 8.1 | 6.33 | 7.07 | 7.35 | 7.59 | 8.4 | 7.3 |
| SHOCKtetc ® Air2Gel ⅛″ | 9.5 | 9.9 | 9.4 | | | | | | 9.6 |
| cotton and SHOCKtetc ® | 8.8 | 7.0 | 6.6 | | | | | | 7.5 |
| Gel ⅛″ | | | | | | | | | |
| cotton and SHOCKtetc ® | 7.2 | 7.3 | 7.2 | | | | | | 7.2 |
| Gel ¼″ | | | | | | | | | |

TABLE 9
Material Testing - Average Pressure measured in Newtons (N/cm²)

| | Trial 1 - | Trial 2 - | Trial 3 - | Trial 4 - | Trial 5 - | Trial 6 - | Trial 7 - | Trial 8 - | Average of |
|---|---|---|---|---|---|---|---|---|---|
| | Average | Average | Average | Average | Average | Average | Average | Average | Average |
| | Pressure | Pressure | Pressure | Pressure | Pressure | Pressure | Pressure | Pressure | Pressure |
| | (N/cm2) | (N/cm2) | (N/cm2) | (N/cm2) | (N/cm2) | (N/cm2) | (N/cm2) | (N/cm2) | (N/cm2) |
| Sheepskin saddle pad | 1.28 | 1.26 | 1.29 | | | | | | 1.28 |
| Cotton saddle pad | 1.24 | 1.43 | 1.30 | | | | | | 1.32 |
| Gel saddle pad | 1.19 | 1.22 | 1.39 | | | | | | 1.27 |
| Sheepskin | 1.35 | 1.32 | 1.54 | | | | | | 1.40 |
| SHOCKtetc ® Gel ⅛″ | 0.91 | 1.14 | 1.15 | 1.02 | 1.2 | 1.18 | 1.17 | 0.95 | 1.09 |
| SHOCKtetc ® Gel ¼″ | 1.08 | 1.10 | 1.19 | 1.22 | 1.33 | 1.38 | 1.34 | 1.37 | 1.25 |
| SHOCKtetc ® Air2Gel ⅛″ | 1.26 | 1.45 | 1.35 | | | | | | 1.35 |
| cotton and SHOCKtetc ® | 1.00 | 1.22 | 1.17 | | | | | | 1.13 |
| Gel ⅛″ | | | | | | | | | |
| cotton and SHOCKtetc ® | 1.28 | 1.29 | 1.27 | | | | | | 1.28 |
| Gel ¼″ | | | | | | | | | |

In Phase 2B, the laboratory testing of the materials was done with weight scaled to produce approximately the same average pressures as was seen in Phase 1 when the commercial saddle pads were tested on the horse.

SHOCKtec ⅛″ gel consistently shows the lowest MOF with the other two SHOCktec materials having the next lowest forces recorded and they have similar results. Note that the first 3 columns in each group are individual tests and the last column in each group are the average of the individual trials (see FIG. 10).

SHOCKtec ⅛ gel consistently resulted in the lowest peak pressures of all the materials tested. Note that the first 3 columns in each group are individual tests and the last column are the average of the individual trials (see FIG. 11).

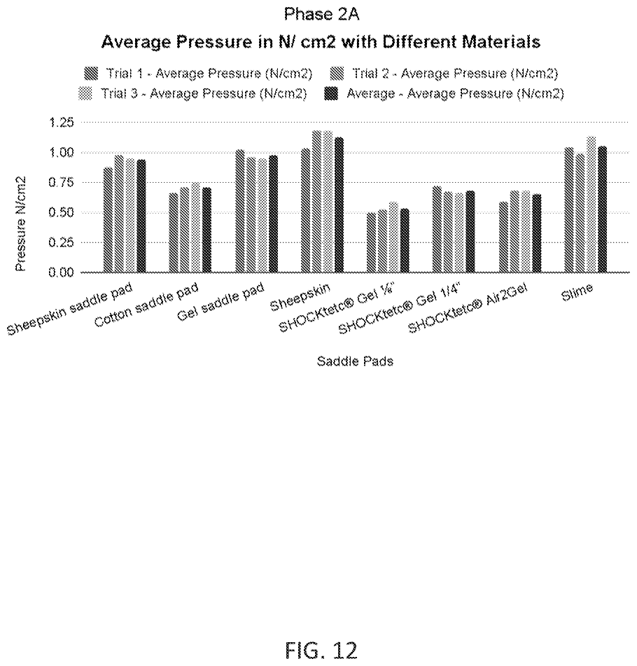

SHOCKtec ⅛″ gel shows the lowest average pressures recorded. The SHOCKtec ¼ and ⅛ inch gel was tested with 8 trials to verify the consistency of the results to ensure the best performing material was chosen for phase 4. first 3 columns in each group are individual tests and the last column are the average of the individual trials (see FIG. 12).

SHOCKtec Saddle Pad

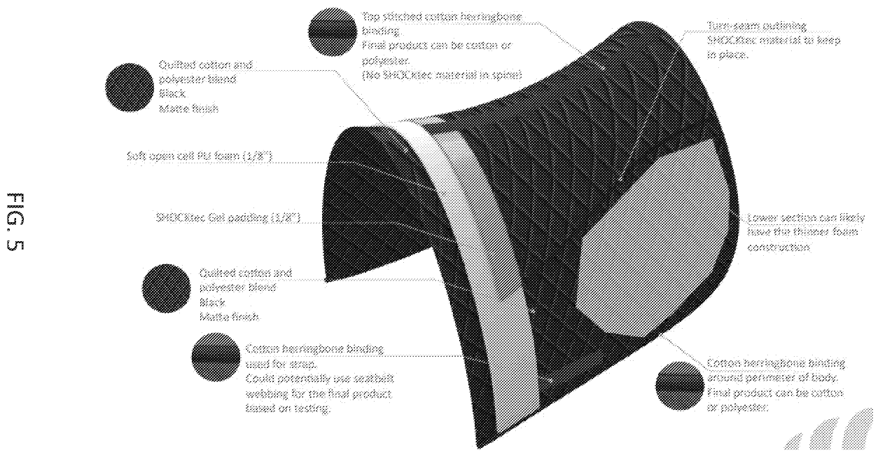

A saddle pad was constructed based on the observations from the experiments set forth above. The new saddle pad comprises a SHOCKtec® Gel ⅛″. a quilted outer shell and a foam layer (see FIG. 5)

The SHOCKtec saddle pad was tested with the method as set forth above.

TABLE 10
Comparison of Cotton Commercial Saddle Pad versus Engineered
Saddle Pad-Pressure on the Spine

| | | | | Pressure |
|---|---|---|---|---|
| | | Trial 2- | Trial 3- | on Spine |
| | Trial 1- | Pressure | Pressure | Average |
| | Pressure on | on Spine | on Spine | (score |
| | Spine (score | (score | (score | out |
| | out of 10) | out of 10) | out of 10) | of 10) |
| Horse 1-Cotton | 3 | 3 | 3 | 3 |
| Horse 1-New Saddle Pad | 3 | 3 | 3 | 3 |
| Horse 2-Cotton | 3 | 3 | 3 | 3 |
| Horse 2-New Saddle Pad | 3 | 6 | 6 | 5 |
| Horse 3-Cotton | 3 | 3 | 3 | 3 |
| Horse 3-New Saddle Pad | 3 | 3 | 3 | 3 |
| Horse 4 Cotton | 3 | 8 | 6 | 5.7 |
| Horse 4 New Saddle Pad | 8 | 3 | 3 | 4.7 |
| Horse 5 Cotton | 3 | 3 | 3 | 3 |
| Horse 5 New Saddle Pad | 3 | 3 | 3 | 3 |

TABLE 11
Comparison of Cotton Commercial Saddle Pad versus Engineered Saddle
Pad-Measurement of Maximum Overall Force (MOF) in Newtons (N)

| | Trial 1- | Trial 2- | Trial 3- | Average- |
|---|---|---|---|---|
| | MOF (N) | MOF (N) | MOF (N) | MOF (N) |
| Horse 1-Cotton | 1616.9 | 1700.5 | 1693.0 | 1670.1 |
| Horse 1-New Saddle Pad | 1592.3 | 1566.0 | 1715.5 | 1624.6 |
| Horse 2-Cotton | 1409.2 | 1497.9 | 1442.7 | 1449.9 |
| Horse 2-New Saddle Pad | 1298.4 | 1396.4 | 1289.0 | 1327.9 |
| Horse 3-Cotton | 1327.6 | 1059.9 | — | 1193.7 |
| Horse 3-New Saddle Pad | 826.6 | 1199.4 | — | 1013.0 |
| Horse 4 Cotton | 726.4 | 1281.2 | 759.2 | 922.3 |
| Horse 4 New Saddle Pad | 511.7 | 369.5 | 909.9 | 597.0 |
| Horse 5 Cotton | 567.1 | 654.3 | 570.8 | 597.4 |
| Horse 5 New Saddle Pad | 591.0 | 396.1 | 329.6 | 438.9 |

TABLE 12
Comparison of Cotton Commercial Saddle Pad versus Engineered Saddle
Pad-Peak Pressure in N/cm²

| | Trial 1- | Trial 2- | Trial 3- | Average- |
|---|---|---|---|---|
| | Peak | Peak | Peak | Peak |
| | Pressure | Pressure | Pressure | Pressure |
| | (N/cm2) | (N/cm2) | (N/cm2) | (N/cm2) |
| Horse 1-Cotton | 7.2 | 7.3 | 7.2 | 7.2 |
| Horse 1-New Saddle Pad | 6.0 | 7.2 | 7.6 | 6.9 |
| Horse 2-Cotton | 7.5 | 7.5 | 7.1 | 7.4 |
| Horse 2-New Saddle Pad | 6.8 | 7.6 | 7.3 | 7.2 |
| Horse 3-Cotton | 7.4 | 6.9 | — | 7.2 |
| Horse 3-New Saddle Pad | 5.9 | 6.8 | — | 6.4 |
| Horse 4 Cotton | 5.3 | 7.0 | 6.1 | 6.1 |
| Horse 4 New Saddle Pad | 5.5 | 4.1 | 4.9 | 4.8 |
| Horse 5 Cotton | 5.7 | 6.7 | 6.0 | 6.1 |
| Horse 5 New Saddle Pad | 4.9 | 4.7 | 4.7 | 4.8 |

TABLE 13
Comparison of Cotton Commercial Saddle Pad versus Engineered Saddle
Pad-Average Pressure in N/cm²

| | Trial 1- | Trial 2- | Trial 3- | Average- |
|---|---|---|---|---|
| | Average | Average | Average | Average |
| | Pressure | Pressure | Pressure | Pressure |
| | (N/cm2) | (N/cm2) | (N/cm2) | (N/cm2) |
| Horse 1-Cotton | 1.33 | 1.40 | 1.43 | 1.39 |
| Horse 1-New Saddle Pad | 1.01 | 1.05 | 1.06 | 1.04 |
| Horse 2-Cotton | 1.33 | 1.34 | 1.26 | 1.31 |
| Horse 2-New Saddle Pad | 0.92 | 1.14 | 1.16 | 1.07 |
| Horse 3-Cotton | 1.45 | 1.23 | — | 1.34 |
| Horse 3-New Saddle Pad | 0.76 | 1.14 | — | 0.95 |
| Horse 4 Cotton | 0.90 | 1.38 | 1.02 | 1.10 |
| Horse 4 New Saddle Pad | 0.76 | 0.49 | 0.77 | 0.67 |
| Horse 5 Cotton | 0.84 | 0.96 | 0.90 | 0.90 |
| Horse 5 New Saddle Pad | 0.72 | 0.64 | 0.58 | 0.65 |

Pressure on Spine in is given a score out 10. The software analyzes the pressure distribution very close to the centerline of the pressure mat which lies over the horse's spine. If 5-9 adjacent pressure points are triggered then there is a minor pressure warning (7-8/10), if 10-14 adjacent pressure points are triggered then there is a warning (5-6/10) and if more than 15 adjacent pressure points are triggered then the software indicates that attention is required (≤4/10).

Although there are slight variations on two horses for the pressure on the spine, overall the results show no consistent difference. Horse number 2 showed an improvement in the score of the pressure on the spine—average of 5/10 (new engineered saddle pad) versus 3/10 (cotton saddle pad). Horse number 4 showed a slightly worse score of 4.7/10 (new engineered saddle pad) verus 5.7/10 (cotton saddle pad).

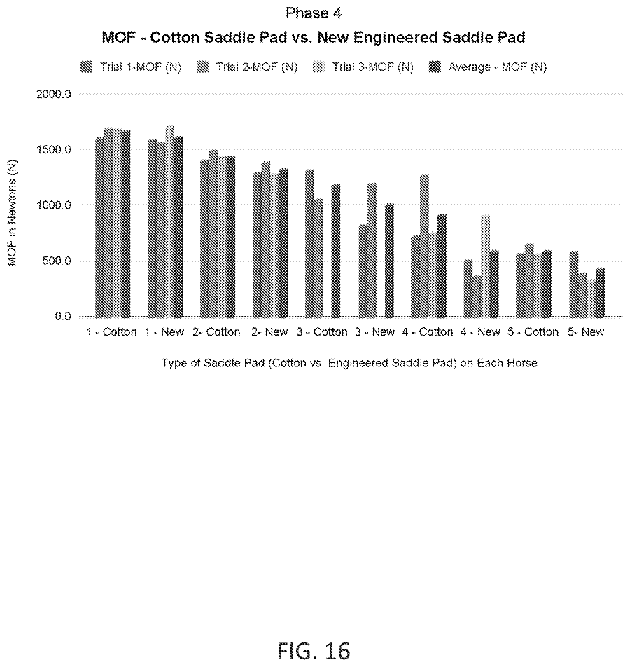

FIG. 16 illustrates the maximum overall forces when tested on each of 5 horses comparing cotton and pads of the present invention. The first 3 columns in each group shows the individual trials and the last column in each group shows the average of each set of trials. It is important to compare the results for each horse directly ie. horse 1 cotton to horse 1 new.

When doing a consistent reduction of maximum overall force with the new engineered saddle pad compared to the cotton saddle pad is observed. Based on a one-tailed sign test, the difference between the average MOF on the cotton pad and the new engineered pad is statistically significant with a p value of 0.01267.

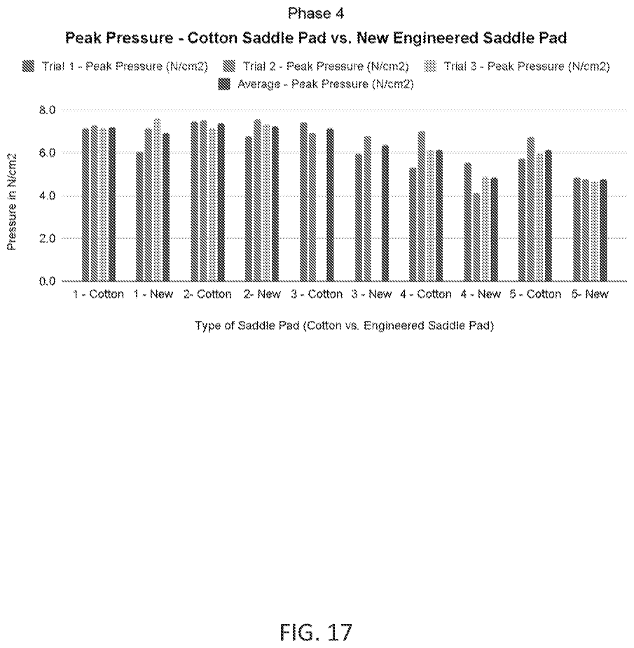

In the graph of FIG. 17 the peak pressures are illustrated when tested on each of 5 horses comparing cotton and new engineered pads. The pink columns show the individual trials and the black columns show the average of each set of trials. It is important to compare the results for each horse directly ie. horse 1 cotton to horse 1 new. When doing this you see that the average shows a consistent reduction of peak pressure with the new engineered saddle pad compared to the cotton saddle pad. Based on a one-tailed sign test, the difference between the average peak pressure on the cotton pad and the new engineered pad is statistically significant with a p value of 0.01267.

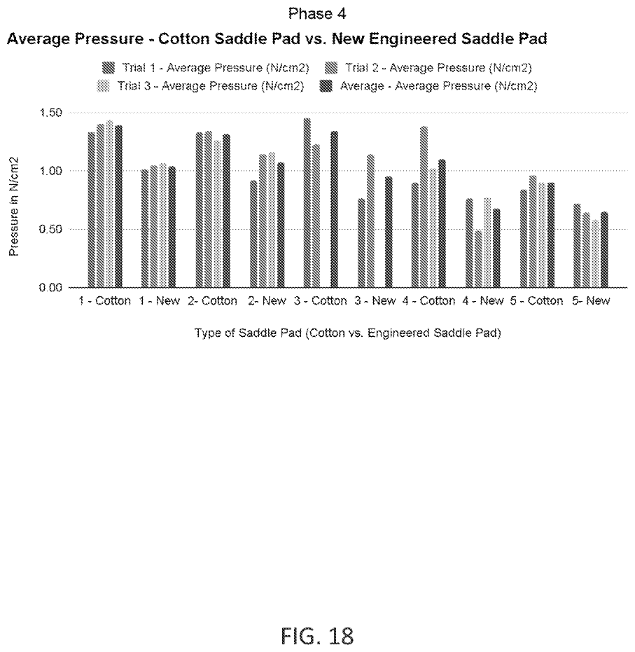

In the graph of FIG. 18 the average pressures are illustrated when tested on each of 5 horses comparing cotton and new engineered pads. The pink columns show the individual trials and the black columns show the average of each set of trials. It is important to compare the results for each horse directly ie. horse 1 cotton to horse 1 new. When doing this you see that it shows a consistent reduction of average pressure on each horse with the new engineered saddle pad compared to the cotton saddle pad. Note that horse 3 only has 2 measurements. This is because the rider fell off the horse during the testing, preventing the completion of the third trial. Based on a one-tailed sign test, the difference between the average of the average pressure on the cotton pad and the new engineered pad is statistically significant with a p value of 0.01267.

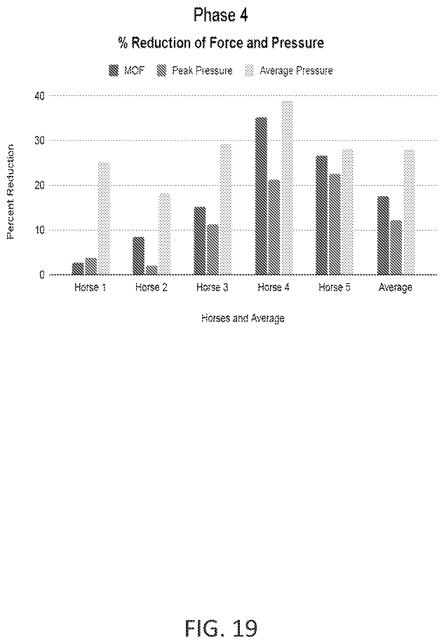

The graph of FIG. 19 shows the percent reduction in MOF (dark pink), peak pressure (bright pink) and average pressure (light pink). The last set of columns shows the MOF is reduced by 18%, the peak pressures are reduced by 12% and the average pressures are reduced by 28%.

TABLE 14
Percent Reduction of Force and Pressure with statistical significance

| | | Peak | Average |
|---|---|---|---|
| | MOF | Pressure | Pressure |
| Horse 1 | 2.7 | 3.75 | 25 |
| Horse 2 | 8.4 | 2.04 | 18.1 |
| Horse 3 | 15.1 | 11.25 | 29.1 |
| Horse 4 | 35.3 | 21.22 | 38.8 |
| Horse 5 | 26.5 | 22.6 | 28.1 |
| Average | 17.6 | 12.2 | 27.8 |
| Standard | 11.9 | 8.5 | 6.7 |
| Deviation | | | |
| 95% | 7.2-28 | 4.75-19.6 | 21.9-33.7 |
| Confidence | | | |
| Interval | | | |

This table shows the average percent reduction for force (MOF) and pressure (average and peak pressures). It also shows the standard deviation which is a measure of the variation in the data. This table also shows the confidence interval. Confidence interval (CI) is the probability (how certain) that the actual value falls within a certain range. For this experiment the CI is the highest for the average pressure. It is 95% confidence that the actual values between 21.9 and 33.7% reduction in average pressure. The 95% confidence interval for peak pressure is 4.75 to 19.6 and for MOF is 7.2-28. In calculating these values a normal distribution was assumed.

### CONCLUSION

In conclusion, a saddle pad using ⅛″ SHOCKtec gel decreased the force on a horse's back and decreased peak and average pressure on the horse's back while jumping. The percent reduction of MOF, peak and average pressures were significant with a p-value of 0.01. Physically, although any reduction in pressure is important, the reduction was much larger (% reduction in average pressure of 27.8%) than that seen between commercially available cotton and sheepskin saddle pads (% reduction in average pressure of 6.9%). In some horses it even reduced the average pressure to be below 0.8 N/cm², a critical pressure value that, when consistently applied for 2 hours, is known to cause hypoxia to the horse's back muscles.

### REFERENCES

Clayton, H. (2016, Oct. 24). horse-health connection—The Science of Saddle Pads. USDF. https://www.usdf.org/EduDocs/Tack/Saddle_Pads.pdf
Di Pietra, D. (2015). Equine Pressure Sensor Pads. Synergist Saddles. https://www.synergistsaddles.com/equine-pressure-sensor-pads/
Estride. (n.d.). Harmony G3 User Manual and FAQ. Retrieved Dec. 15, 2021, from https://estride.freshdesk.com/support/home
Harman, J. (2016. Oct. 26). Understanding Saddle Fit, Part I: An Overview. https://www.horsenation.com/2016/10/26/understanding-saddle-fit-part-i-an-overview/
Harman, J. (2016, Nov. 9). Understanding Saddle Fit, Part Ill: Is It a Fit? from https://www.horsenation.com/2016/11/09/understanding-saddle-fit-part-iii-is-it-a-fit/
Janura, M. (2012). Pferdeheikunde 28, 5, 583-593.
Kotschwar, A. B. (2010). The Veterinary Journal, 184, 322-325. 10.1016/j.ttvjl.2009.02.018
Lesté, C. (2019, Feb. 4). The Saddle Pad Science. https://thinlinecanada.ca/2019/02/04/the-saddle-pad-science/
Schleese, J. (2017, Jul. 5). Jochen Schleese Saddle Fitting Tip—Balance and Rider Position. EquiSearch. https://www.equisearch.com/articles/jochen-schleese-saddle-fitting-tip-balance-and-rider-position
SHOCKtec Inc. (2021). SHOCKtec Info Sheet 2021.
von Peinen. K. (2010). Equine Veterinary Journal, 42(38), 650-653. 10.1111/j.2042-3306.2010.00191.x

1. A saddle pad comprising a force dissipation material, said force dissipation material comprising a dry visoelastic polymer.

2. The saddle pad of claim 1, wherein the force dissipation material is an air-frothed visoelastic dry polymer.

3. The saddle pad of claim 1, wherein said force dissipation material comprises SHOCKtec gel™ or SHOCKtec Air2Gel™.

4. The saddle pad of claim 1, wherein the saddle pad comprises a spine portion and two side portions extending out from each side of the spine portion, and wherein each side portion comprises said force dissipation material and said spine does not contain said force dissipation material.

5. The saddle pad of claim 4, wherein said force dissipation material comprises SHOCKtec gel™ or SHOCKtec Air2Gel™.

6. The saddle pad of claim 5, further comprising an outer shell.

7. The saddle pad of claim 6, further comprising a layer of foam.
